(19) United States
(12) Patent Application Publication
(10) Pub. No.: US 2019/0100959 A1
(43) Pub. Date: Apr. 4, 2019

(54) ROLLER SHADE

(71) Applicant: Yu-Chen Chang, Changhua (TW)

(72) Inventor: Yu-Chen Chang, Changhua (TW)

(21) Appl. No.: 15/721,913

(22) Filed: Oct. 1, 2017

(51) Int. Cl. E06B 9/262; E06B 9/322; E06B 9/382; A47H 23/01; A47H 23/14

(52) U.S. Cl. CPC E06B 9/262; E06B 9/322; E06B 2009/3222; A47H 23/01; A47H 23/14; E06B 9/382

(57) ABSTRACT

A roller shade may comprise a main body having a plurality of horizontal parallel cylinders woven together into a panel by a plurality of vertical first weaving threads. Each of two surfaces of the main body comprises a plurality of fastener tapes secured thereon through a plurality of second weaving threads, and the fastener tapes on one surface of the main body are located at positions corresponding to the fastener tapes on the other surface thereof. When the main body is rolled up, the fastener tapes at corresponding positions can be latched together to secure the rolled main body at a desired height.

### FIELD OF THE INVENTION

The present invention relates to a roller shade and more particularly to a cordless roller shade.

### BACKGROUND OF THE INVENTION

Generally, a conventional roller shade has a lift mechanism including lift cords which enable the shade to be rolled up and down to block sunlight and achieve decoration.

However, the conventional roller shade is disadvantageous because: the looped lift cords suspended beside the shade are easy to reach by child, which might lead to accident and injury. Therefore, there remains a need for a new and improved design for a roller shade to overcome the problems presented above.

### SUMMARY OF THE INVENTION

The present invention provides a cordless roller shade which comprises a main body, and the main body has a plurality of horizontal parallel cylinders woven together into a panel by a plurality of vertical first weaving threads. A top end of the main body is folded over to form a connecting portion, and a pair of top bars is configured to fit together to cover the connecting portion. Moreover, a plurality of first connecting members respectively penetrate through the two top bars and the cylinders between the two top bars to secure positions therebetween, and at least two hanging members are respectively connected to the top bars. Furthermore, a pair of bottom bars is configured to fit together to cover a bottom end of the main body, and a plurality of second connecting members respectively penetrate through the two bottom bars and the cylinders therebetween to secure the bottom bars at the bottom end of the main body. Each of two surfaces of the main body comprises a plurality of fastener tapes secured thereon through a plurality of second weaving threads, and the fastener tapes on one surface of the main body are located at positions corresponding to the fastener tapes on the other surface thereof.

In one embodiment, each of the surfaces of the main body has at least two vertical fastener tapes, and each of the two fastener tapes on one surface of the main body comprises a hook surface while each of the two fastener tapes on the other surface of the main body has a loop surface which is configured to be caught by the hook surface at the corresponding position.

In another embodiment, both surfaces of the main body comprise the plurality of horizontal parallel fastener tapes, and each of the fastener tapes on one surface of the main body has the hook surface while each of the fastener tapes on the other surface of the main body comprises the loop surface.

In still another embodiment, each of the surfaces of the main body comprises at least two fastener tapes, and each of the fastener tapes has the plurality of hook surfaces and the plurality of loop surfaces arranged in an alternative pattern.

In a further embodiment, the cylinders are made of bamboo.

In still a further embodiment, the pair of bottom bars has sufficient weight to prevent the main body from flying away with the wind.

Comparing with conventional roller shade, the present invention is advantageous because: (i) through the hook surfaces catching the loop surfaces, the rollable main body can be secured at a desired height easily; (ii) the main body can be rolled up and down without lift cords, which is safer to use; (iii) the main body is made up of the plurality of horizontal parallel cylinders, which enhances the stability of rolling process and prevents the occurrence of accidents when in use; and (iv) the fastener tapes are secured on the both surfaces of the main body through the second weaving threads, which significantly prevents the fastener tapes from been torn down from the main body incautiously and further improves the life time of the roller shade.

### BRIEF DESCRIPTION OF THE DRAWINGS

FIG. 1 is a three-dimensional assembly view of a roller shade in the present invention.

FIG. 2 is a three-dimensional exploded view of the roller shade in the present invention.

FIG. 3 is a front view of reduced size of the roller shade in the present invention.

FIG. 4 is a sectional view of FIG. 3 along line A-A.

FIG. 5 is a partial enlarged view of FIG. 4.

FIG. 6 is a schematic view illustrating the roller shade of the present invention is in a rolled position.

FIG. 7 is a partial enlarged view of FIG. 6.

FIG. 8 is a three-dimensional assembly view of a second embodiment of the roller shade in the present invention.

FIG. 9 is a schematic view illustrating the second embodiment of the roller shade of the present invention is rolled up.

FIG. 10 is a three-dimensional assembly view of a third embodiment of the roller shade in the present invention.

FIG. 11 is a schematic view illustrating the third embodiment of the roller shade of the present invention is rolled up.

FIG. 12 is a schematic view illustrating hook surfaces and loop surfaces arranged in an alternative pattern on a single fastener tape secured on a main body of the roller shade are latched together when the main body is horizontally folded over.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

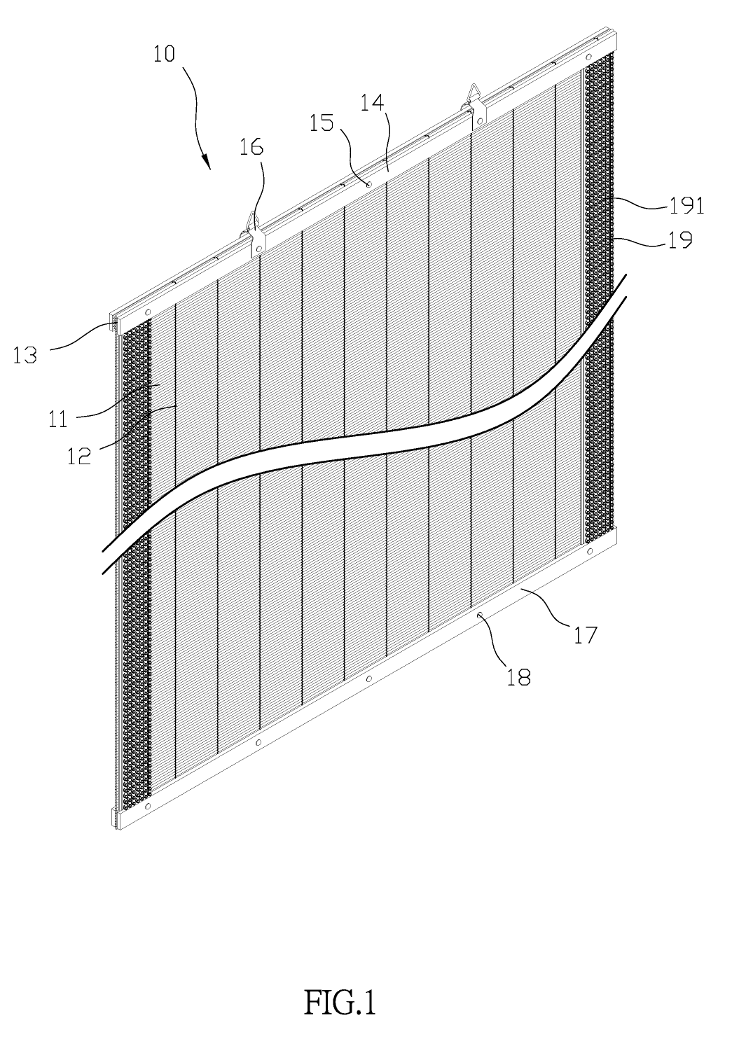

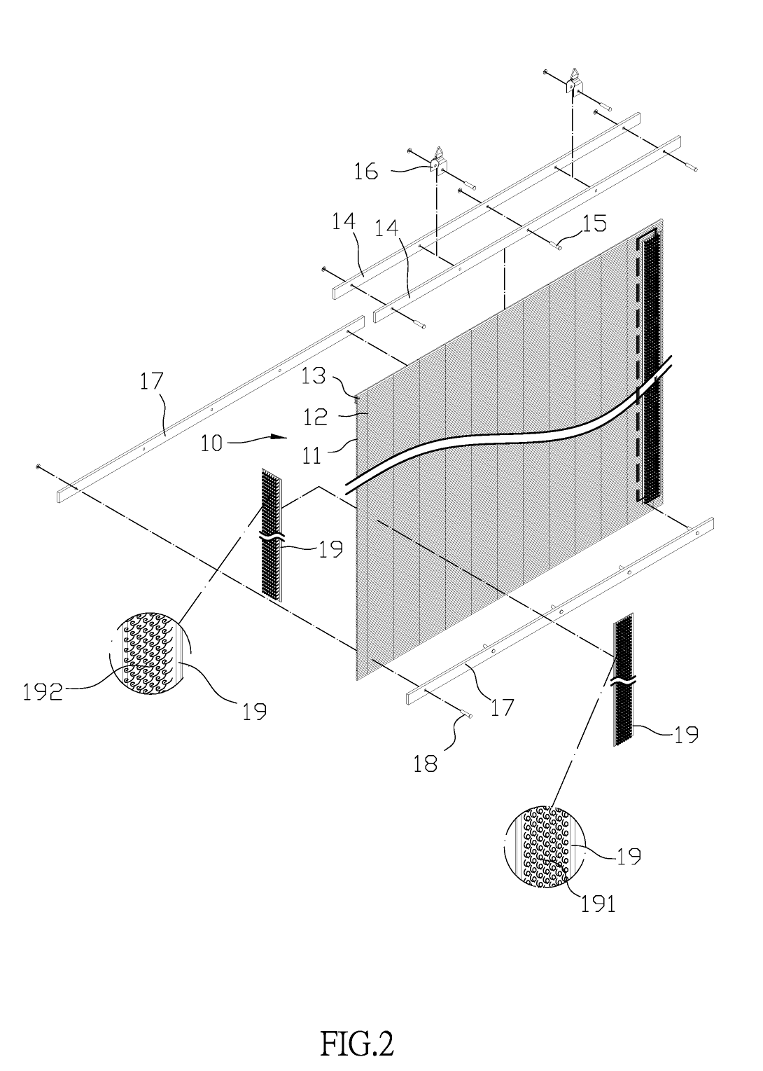

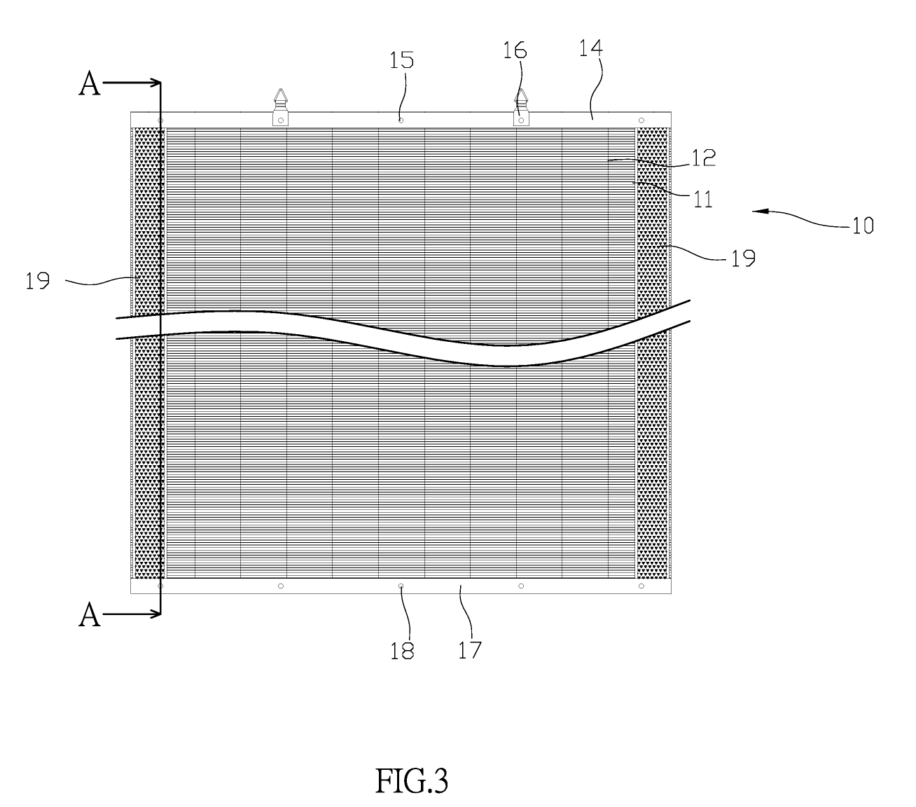

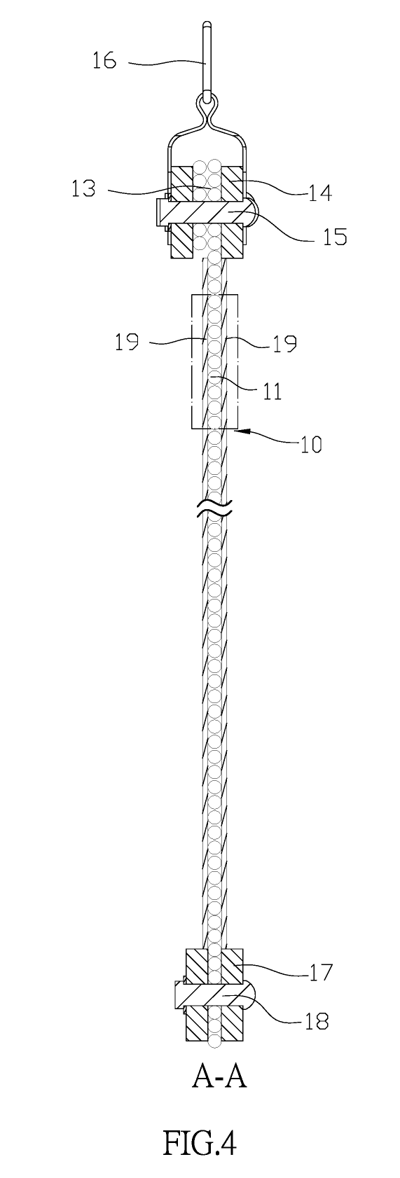

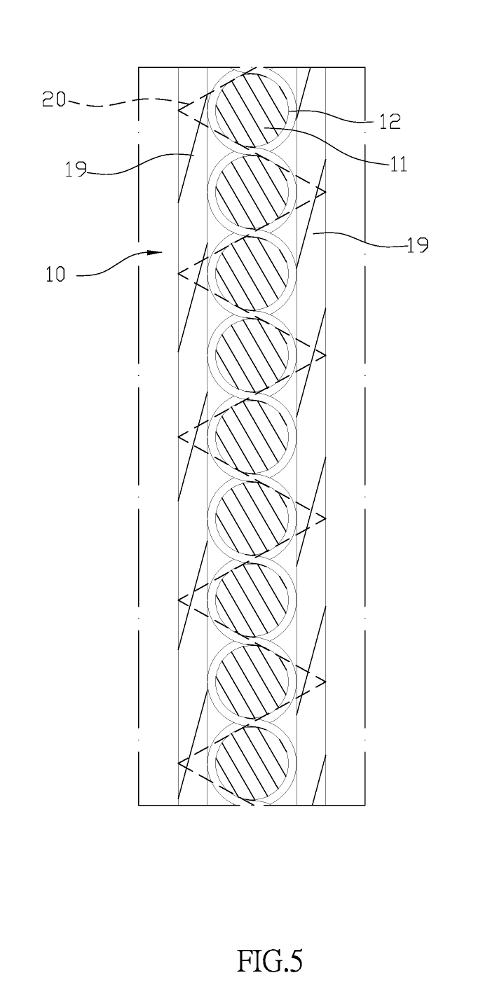

Referring to FIGS. 1 to 5, the present invention provides a cordless roller shade which comprises a main body (10), and the main body (10) has a plurality of horizontal parallel cylinders (11) woven together into a panel by a plurality of vertical first weaving threads (12). A top end of the main body (10) is folded over to form a connecting portion (13), and a pair of top bars (14) is configured to fit together to cover the connecting portion (13). Moreover, a plurality of first connecting members (15) respectively penetrate through the two top bars (14) and the cylinders (11) between the two top bars (14) to secure positions therebetween, and at least two hanging members (16) are respectively connected to the top bars (14). Furthermore, a pair of bottom bars (17) is configured to fit together to cover a bottom end of the main body (10), and a plurality of second connecting members (18) respectively penetrate through the two bottom bars (17) and the cylinders (11) therebetween to secure the bottom bars (17) at the bottom end of the main body (10). Each of two surfaces of the main body (10) comprises a plurality of fastener tapes (19) secured thereon through a plurality of second weaving threads (20), and the fastener tapes (19) on one surface of the main body (10) are located at positions corresponding to the fastener tapes (19) on the other surface thereof. Preferably, each of the surfaces of the main body (10) has at least two vertical fastener tapes (19), and each of the two fastener tapes (19) on one surface of the main body (10) comprises a hook surface (191) while each of the two fastener tapes (19) on the other surface of the main body (10) has a loop surface (192) which is configured to be caught in by the hook surface (191) at corresponding position.

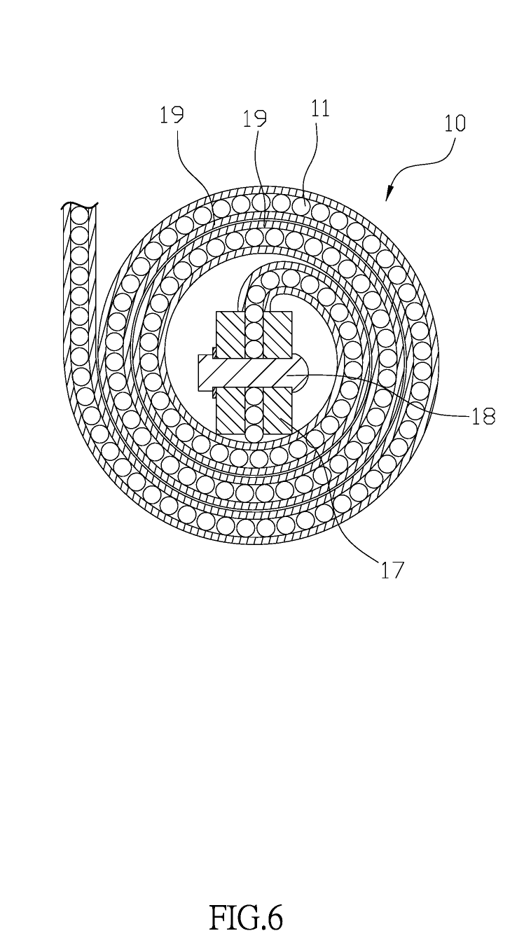

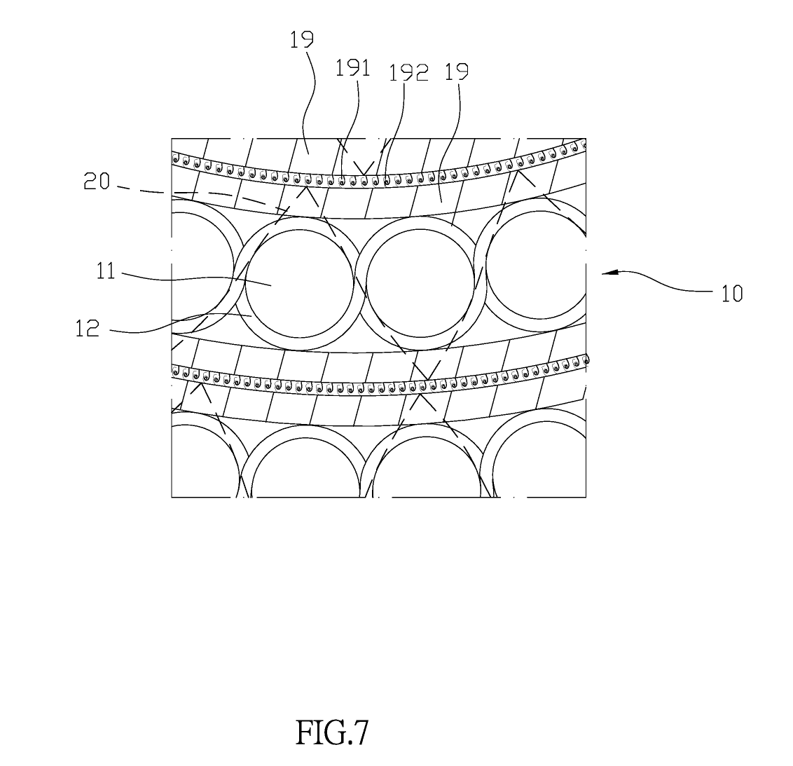

Structurally, referring to FIGS. 1, 6 and 7, the main body (10) is hooked on to a window frame through the hanging members (16), and the roller shade can be rolled up and down by a user to achieve the effect of UV blocking, glare reducing or decoration. When the main body (10) is rolled up from the bottom bars (17) in one direction, the hook surfaces (191) of the fastener tapes (19) on one surface of the main body (10) are configured to catch the corresponding loop surfaces (192) of the fastener tapes (19) on the other surface of the main body (10) such that the main body (10) can be secured at any height during rolling process. On the other hand, when the rolled main body (10) needs to be released, a user can roll the bottom bars (17) in the other direction to pull or peel the hook surfaces (191) and the corresponding loop surfaces (192) apart till the main body (10) is rolled back down to a desired height.

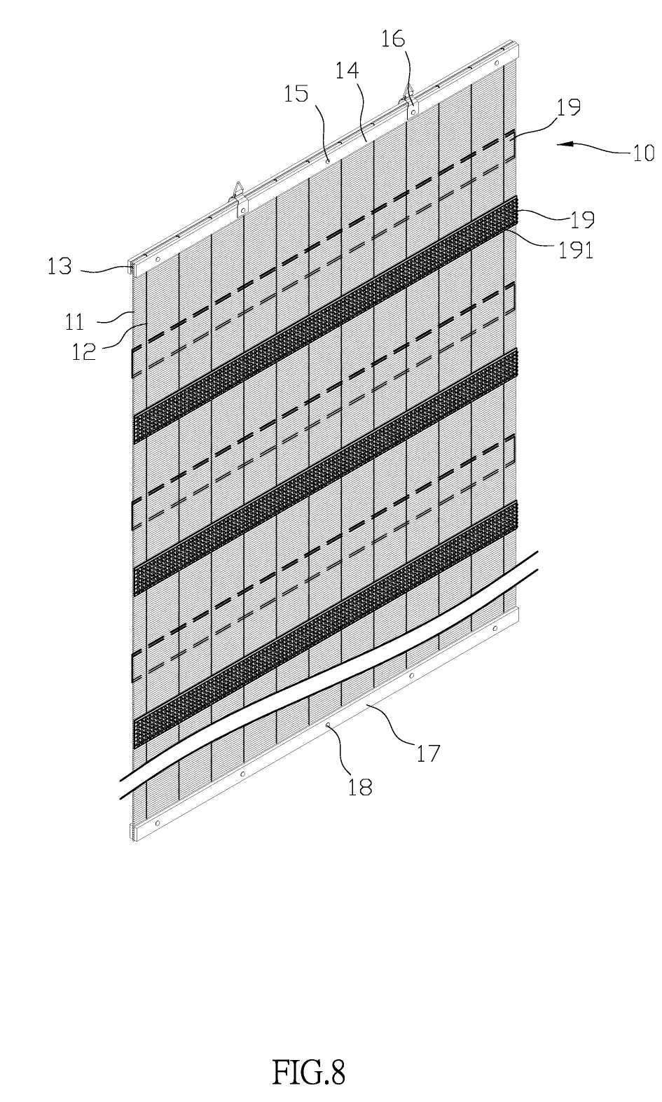

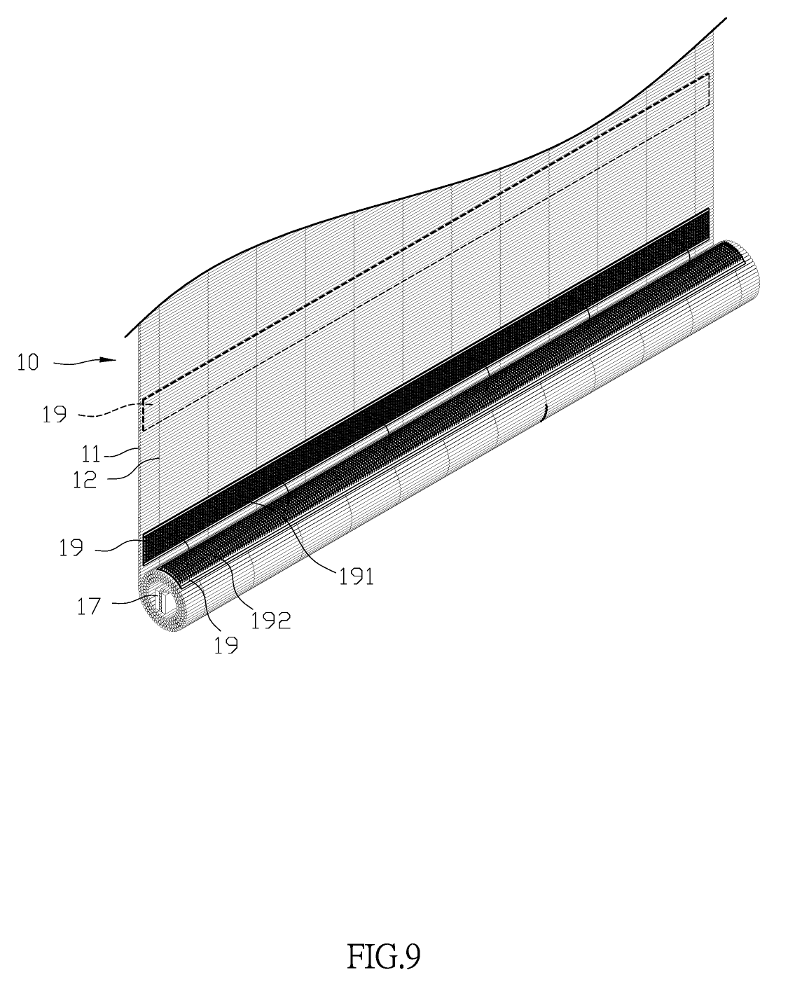

Referring to FIGS. 8 and 9, in one embodiment, the fastener tapes (19) secured on each of the two surfaces of the main body (10) are arranged in a horizontal direction and parallel with each other, and when the main body (10) is rolled up from the bottom bars (17), each of the hook surfaces (191) on one surface of the main body (10) is configured to catch the entire corresponding loop surface (192), which improves the binding strength therebetween and further enhances the effect of positioning main body (10) during the rolling process.

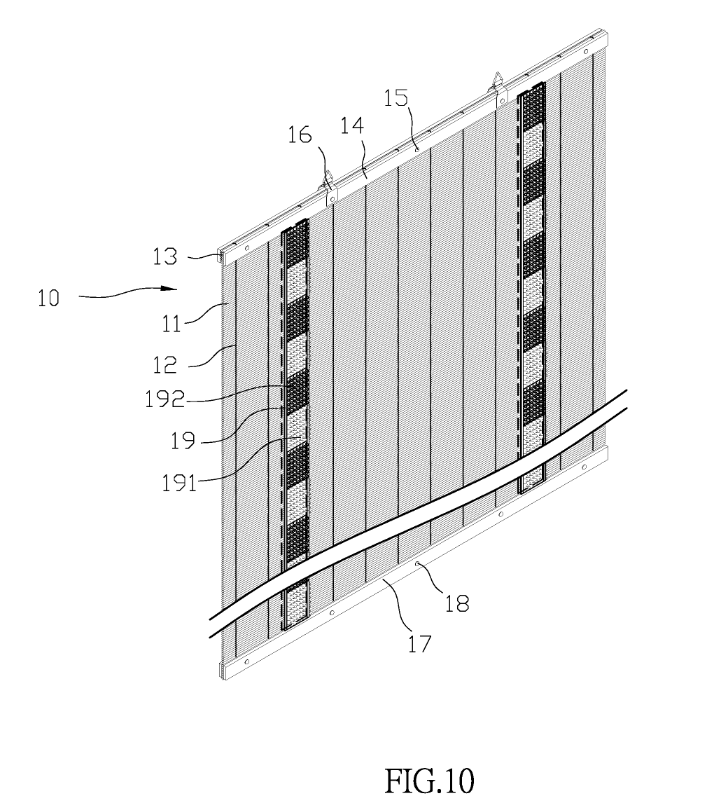

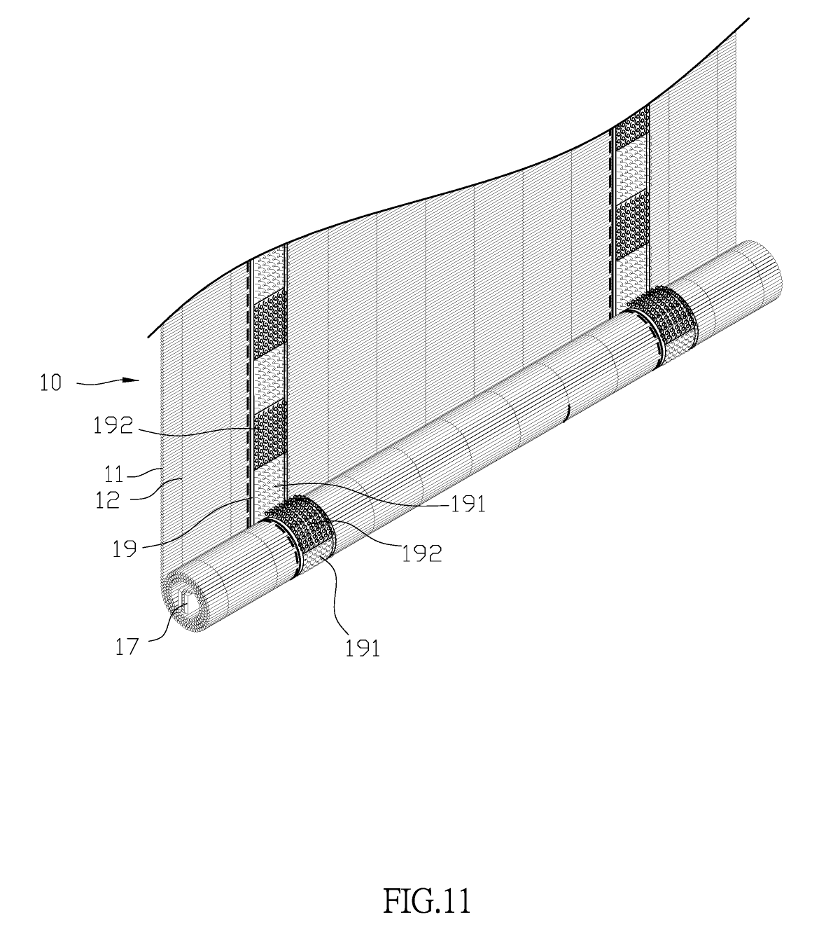

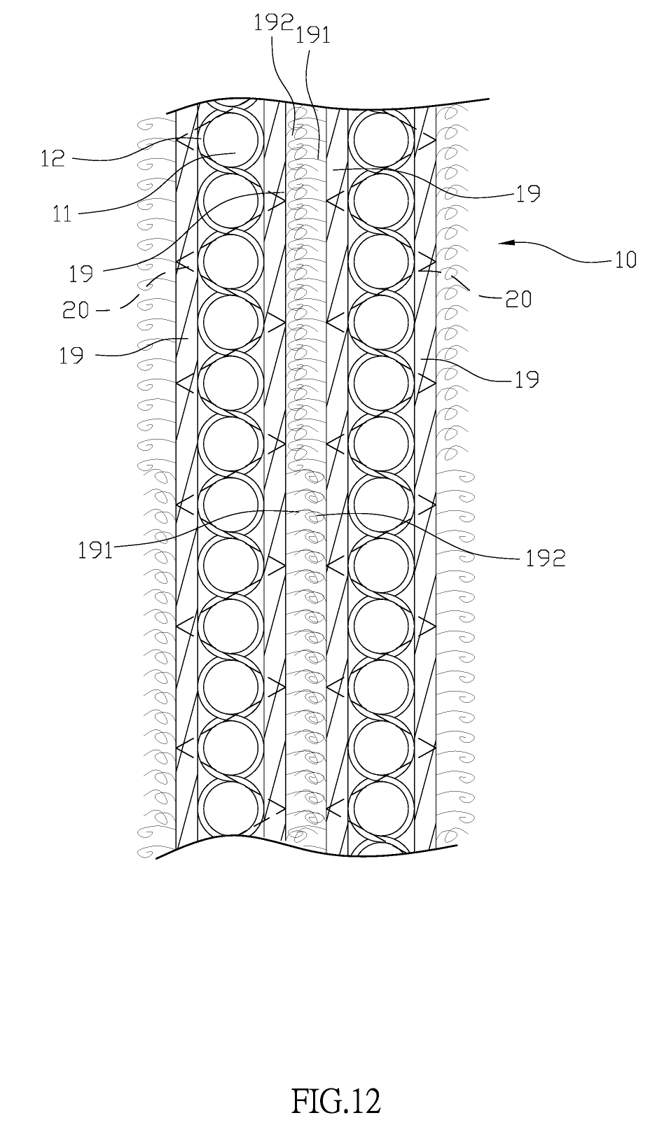

Referring to FIG. 10, in another embodiment, each of the surfaces of the main body (10) comprises at least two fastener tapes (19), and the two fastener tapes (19) on one surface of the main body (10) are located at positions corresponding to the two fastener tapes (19) on the other surface of the main body (10). Furthermore, each of the fastener tapes (19) has the plurality of hook surfaces (191) and the plurality of loop surfaces (192) arranged in an alternative pattern such that the main body (10) is configured to be rolled and secured at a desired height to achieve the effect of glare reducing (as shown in FIG. 11) or to be folded up to enable the hook surfaces (191) to catch the loop surfaces (192) on the same surface of the main body (10) (as shown in FIG. 12), thereby enabling the roller shade of the present invention to be used as a Roman shade.

In still another embodiment, the cylinders (11) are made of bamboo.

In a further embodiment, the pair of bottom bars (17) has sufficient weight to prevent the main body (10) from flying away with the wind.

Comparing with conventional roller shade, the present invention is advantageous because: (i) through the hook surfaces (191) catching the loop surfaces (192), the rollable main body (10) can be secured at a desired height easily; (ii) the main body (10) can be rolled up and down without lift cords, which is safer to use; (iii) the main body (10) is made up of the plurality of horizontal parallel cylinders (11), which enhances the stability of rolling process and prevents the occurrence of accidents when in use; and (iv) the fastener tapes (19) are secured on the both surfaces of the main body (10) through the second weaving threads (20), which significantly prevents the fastener tapes (19) from been torn down from the main body (10) incautiously and further improves the life time of the roller shade.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A roller shade comprising:
a main body having a plurality of horizontal parallel cylinders woven together into a panel by a plurality of vertical first weaving threads; a top end of the main body folded over to form a connecting portion, and a pair of top bars configured to fit together to cover the connecting portion; a plurality of first connecting members respectively penetrating through the two top bars and the cylinders between the two top bars to secure positions therebetween, and at least two hanging members respectively connected to the top bars; a pair of bottom bars configured to fit together to cover a bottom end of the main body, and a plurality of second connecting members respectively penetrating through the two bottom bars and the cylinders therebetween to secure the bottom bars at the bottom end of the main body; each of two surfaces of the main body comprising a plurality of fastener tapes secured thereon through a plurality of second weaving threads, and the fastener tapes on one surface of the main body located at positions corresponding to the fastener tapes on the other surface thereof; and when the main body rolled up, the fastener tapes at the corresponding positions configured to be latched together to secure the main body at a desired height.

2. The roller shade of claim 1, wherein each of the surfaces of the main body has at least two vertical fastener tapes, and each of the two fastener tapes on one surface of the main body comprises a hook surface while each of the two fastener tapes on the other surface of the main body has a loop surface which is configured to latch together with the hook surface at the corresponding position.

3. The roller shade of claim 1, wherein both surfaces of the main body comprise the plurality of horizontal parallel fastener tapes, and each of the fastener tapes on one surface of the main body has the hook surface while each of the fastener tapes on the other surface of the main body comprises the loop surface.

4. The roller shade of claim 1, wherein each of the surfaces of the main body comprises at least two fastener tapes, and each of the fastener tapes has the plurality of hook surfaces and the plurality of loop surfaces arranged in an alternative pattern.

5. The roller shade of claim 1, wherein the cylinders are made of bamboo.

6. The roller shade of claim 1, wherein the pair of bottom bars has sufficient weight to prevent the main body from flying away with the wind.
